(19) United States
(12) Patent Application Publication
(10) Pub. No.: US 2008/0090093 A1
(43) Pub. Date: Apr. 17, 2008

(54) Method for the Production of a Composite Component Comprising Two Component Sections with a Basic Adhesive Nickel Layer Located Between the Two Component Sections

(75) Inventor: Reinhold Meier, Dorfen (DE)

Correspondence Address: MCANDREWS HELD & MALLOY, LTD, 500 WEST MADISON STREET, SUITE 3400, CHICAGO, IL, 60661, US

(73) Assignee: MTU AERO ENGINES GMBH, Munich (DE)

(21) Appl. No.: 11/950,202

(22) Filed: Dec. 4, 2007

(30) Foreign Application Priority Data
Jun. 29, 2006 (DE) PCT/DE2006/000115
Jul. 6, 2005 (DE) DE102005031584

(51) Int. Cl. B29C 65/48; B29C 65/06; B32B 7/04

(52) U.S. Cl. 428/577; 156/60; 156/73.5

(57) ABSTRACT

The present technology generally relates to a method for producing a composite component, preferably, a composite gas turbine component, wherein the composite component exhibits a first component section made of a magnesium-based material or an aluminum-based material and a second component section made of a high-strength material, preferably, made of an iron-based or nickel-based or titanium-based or cobalt-based material. The method comprises at least the following steps: a) providing the first component section (11) made of the magnesium-based material or the aluminum-based material; b) coating the first component section (11) made of the magnesium-based material or the aluminum-based material with an adhesive layer (12) in at least one fusion area for the second component section, where a nickel-based material, preferably, a nickel alloy material, is used as the coating material for the adhesive layer; c) providing the second component section (13) made of the high-strength material, preferably, made of the iron-based or nickel-based or titanium-based or cobalt-based material; d) joining the second component section (13) made of the high-strength material to the fusion area, which is coated with the adhesive layer (12) and is part of the first component section (11) made of the magnesium-based material or the aluminum-based material.

### RELATED APPLICATIONS

This application claims priority to PCT Application Serial No. PCT/DE2006/00115, filed Jun. 29, 2006, which further claims priority to German Application Serial No. DE102005031584, filed Jul. 6, 2005, the disclosures of which are hereby incorporated by reference herein in their entireties.

### FEDERALLY SPONSORED RESEARCH OR DEVELOPMENT

[Not Applicable]

### MICROFICHE/COPYRIGHT REFERENCE

[Not Applicable]

### FIELD OF THE INVENTION

The presently described technology, in general, relates to a method for producing a composite component, in particular a composite gas turbine component.

### BACKGROUND OF THE INVENTION

Modern gas turbines, in particular aircraft engines, must satisfy the highest demands in terms of reliability, weight, power output, efficiency and service life. The selection of materials, the search for new suitable materials, as well as the search for new manufacturing processes have played, inter alia, a decisive role in the development of gas turbines.

At least some of the important materials that are used today for aircraft engines or other types of gas turbines are titanium alloys, nickel alloys, and high-strength steels. The high-strength steels are used, for example, as shaft parts, gear parts, compressor housings and turbine housings. Titanium alloys are typical materials for compressor parts. Nickel alloys are typical materials for hot turbine parts. The high-strength steels, titanium alloys as well as nickel alloys have, on the whole, a relatively high specific weight, for which reason these components, which are made of such materials, are relatively heavy. If these components relate to rotating components, the relatively high weight also generates relatively high centrifugal forces in operation, thus resulting in high stresses on the component.

Magnesium-based materials, in particular magnesium alloy materials, as well as aluminum-based materials, have a relatively low specific weight, so that magnesium-based materials and aluminum-based materials can be used to make light-weight components. However, owing to the relatively low modulus of elasticity of magnesium-based materials and aluminum-based materials, such components can be exposed to only low mechanical stresses. Furthermore, components made of magnesium-based materials and aluminum-based materials tend to oxidize, as well as corrode, so that coatings, which adhere firmly to such components, are necessary in order to protect against corrosion and oxidation. Thus, according to DE 199 59 378, a method is described for coating components made of magnesium-based materials, in order to guarantee that such components are effectively shielded against corrosion and oxidation. Since, however, components, which are coated with such an anti-corrosion coating, still have now, as before, a low modulus of elasticity, such components are not suitable for manufacturing, for example, highly stressed, rotating components.

In order to manufacture highly stressed components, the design of such components was offered as a composite component, where a first component section can be made of a magnesium-based material or an aluminum-based material and a second component section can be made of a high-strength material, in particular made of a nickel-based or titanium-based or cobalt-based material. Thus, the weight of the components can be reduced. However, methods, with the aid of which such composite components can be manufactured, are not known from the prior art.

### BRIEF SUMMARY OF THE INVENTION

Starting from the above prior art, the goal of the underlying present technology described and further claimed herein is to provide a novel method for producing a composite component, in particular a composite gas turbine component.

According to one or more aspects of the present technology, the disadvantages of the prior art are overcome by the description provided below and further set forth in the appended claims. In at least one aspect, the present technology provides a method comprising at least the following steps: a) providing a first component section made of the magnesium-based material or the aluminum-based material, in particular made of a magnesium alloy material or an aluminum alloy material; b) coating the first component section made of a magnesium-based material or an aluminum-based material with an adhesive layer in at least one fusion area for the second component section, where a nickel-based material, in particular a nickel alloy material, is used as the coating material for the adhesive layer; c) providing the second component section made of a high-strength material, in particular made of the iron-based or nickel-based or titanium-based or cobalt-based material; d) joining the second component section made of the high-strength material to the fusion area, which is coated with the adhesive layer and is part of the first component section made of the magnesium-based material or the aluminum-based material.

According to another aspect of the presently described technology, the disadvantages of the prior art are overcome by a method comprising at least the following steps: a) providing a first component section made of a magnesium-based material or an aluminum-based material, in particular made of a magnesium alloy material or an aluminum alloy material; b) coating the first component section made of the magnesium-based material or an aluminum-based material with an adhesive layer in at least one fusion area for the second component section, where a nickel-based material, in particular a nickel alloy material, is used as the coating material for the adhesive layer; c) building up a second component section made of a high-strength material, in particular made of the iron-based or nickel-based or titanium-based or cobalt-based material, on the fusion area, which is coated with the adhesive layer and is part of the first component section, by means of laser powder build-up welding.

The fusion area of the first component section is coated with the adhesive layer preferably in that a powdery nickel alloy material is applied on the fusion area of the first component section as the coating material for the adhesive layer, melted by means of laser powder build-up welding, for example, and connected by metallurgical means to the first component section without any deep penetration melting of the material of the fusion area.

Further developments, embodiments and preferences of the present technology are provided in the appended claims and the following description. Various embodiments of the present technology however, are explained in detail with reference to FIG. 1 without being limited thereto.

### BRIEF DESCRIPTION OF SEVERAL VIEWS OF THE DRAWINGS

FIG. 1 is a schematic cross section view of a composite material that is produced with the method according to the invention.

### DETAILED DESCRIPTION OF THE INVENTION

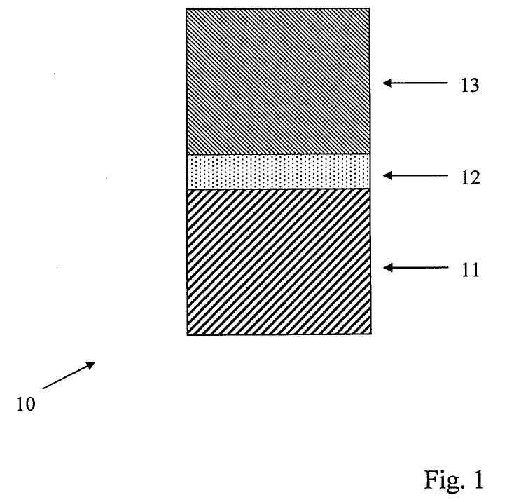

Referring to FIG. 1, the invention is described below in more detail. The presently described technology relates to a method for producing a composite component 10 as noted in FIG. 1. The composite component 10 to be produced has a first component section 11 made of a magnesium-based material or an aluminum-based material and a second component section 13 made of a high-strength material, preferably, made of an iron-based or a nickel-based or titanium-based or cobalt-based material. The following description of the present technology noted below shall be based on at least one aspect or at least one embodiment of that technology in which the first component section 11 is made of a magnesium-based material.

According to a first variant of the inventive methodology of the present technology for producing a composite component, a first component section 11 made of the magnesium-based material is provided. The magnesium-based material is preferably made as a magnesium alloy material. Thereupon, the first component section 11 made of the magnesium alloy material is coated with an adhesive layer 12 in at least one fusion area for the second component section. A nickel-based material, preferably a nickel alloy material, is used as the coating material for the adhesive layer 12. Preferably, the first component section 11 is coated not just in the fusion area for the second component section 13, but rather in its entirety over all surface sections.

The coating of at least the fusion area of the first component section 11 made of the magnesium alloy material with the adhesive layer 12 made of the nickel alloy material is carried out in such a manner that the coating material for the adhesive layer, namely the nickel alloy material, is provided as a powder and is applied at least on the fusion area that is to be coated and is part of the first component section 11. The coating material is melted by means of laser powder build-up welding, for example, and is connected by metallurgical means to the first component section 11 without any deep penetration melting of the magnesium alloy material of the fusion area. In this case, the laser powder build-up welding is carried out, preferably, as a one-step process with the continuous infeed of the powdery nickel alloy material by means of a gas stream, as in the coating process known from, for example, reference DE 199 59 378. With respect to additional details of the coating process for producing the adhesive layer on at least the fusion area of the first component section 11, reference is made to the DE 199 59 378; this reference explicitly refers to the entire disclosure content. Hence, the disclosure content of the DE 199 59 378 is an essential part of this patent application and incorporated by reference in its entirety.

Furthermore, the first variant of the inventive method of the present technology provides the second component section 13 made of the high-strength material, preferably made of the iron-based or nickel-based or titanium-based or cobalt-based alloy material. The first, previously coated component section 11 is connected to the second component section 13 by joining. The second component section 13 made of the high-strength material is joined to the fusion area, which is coated with the adhesive layer 12 and is part of the first component section 11. In this case, the joining is done by welding or soldering, for example. The welding can be carried out, for example, as inductive high frequency pressure welding or electron beam welding or laser beam welding. Prior to joining and/or connecting the first component section and the second component section, the fusion areas of the two component sections are cleansed or rather cleaned—that is, de-oxidized and degreased.

According to a second variant of the inventive method for producing a composite component 10, the first component section 11 made of the magnesium-based material—that is, the magnesium alloy material—is provided and then coated with the adhesive layer 12 made of the nickel alloy material at least in the fusion area for the second component section. Preferably, the first component section made of the magnesium alloy material is coated with the nickel alloy material in such a manner that the first component section is coated totally and/or completely. Once again, the coating process is carried out according to the method disclosed in the DE 199 59 378 reference noted above. According to the second variant of the inventive method, the second component section 13 made of the high-strength material is built up in succession on the fusion area, which is coated with the adhesive layer 12 and is part of the first component section 11, by means of the laser powder build-up welding. In so doing, the material composition of the second component section can be changed.

The presently described technology also proposes a method for producing composite components, which exhibit a first component section made of a magnesium alloy material or an aluminum-based material and a second component section made of a high-strength material, preferably made of an iron alloy or nickel alloy or titanium alloy or cobalt alloy material. The first component section made of the magnesium alloy material or the aluminum-based material is coated, preferably, completely with a nickel-based material, or preferably a nickel alloy material at least in the fusion area for the second component section, in order to form, thus, an adhesive layer for the second component section in the fusion area. The second component section made of the high-strength material is joined either to the fusion area, which is coated with the adhesive layer and is part of the first component section, or is built up on the fusion area, which is coated with the adhesive layer and is part of the first component section, by means of laser powder-build-up welding, for example.

The inventive method can be used, for example, for manufacturing gas turbine blades, fan blades or integrally bladed rotors.

1. A method for producing a composite component, wherein the composite component comprises:
a first component section made of a magnesium-based material or an aluminum-based material; and
a second component section made of a high-strength material, wherein the high-strength material comprises an iron-based. nickel-based, titanium-based or cobalt-based material,
the method comprising the steps of:
a) providing the first component section made of the magnesium-based material or the aluminum-based material;
b) coating the first component section made of the magnesium-based material or the aluminum-based material with an adhesive layer in at least one fusion area for the second component section, wherein a nickel-based material is used as the coating material for the adhesive layer;
c) providing the second component section made of the high-strength material; and
d) joining the second component section made of the high-strength material to the fusion area, which is coated with the adhesive layer and is part of the first component section made of the magnesium-based material or the aluminum-based material.

2. The method according to claim 1, wherein the composite component is a composite gas turbine component.

3. The method according to claim 1, wherein the magnesium-based material or the aluminum-based material is a magnesium alloy material or an aluminum alloy material.

4. The method according to claim 1, wherein the nickel-based material used as the coating material for the adhesive layer is a nickel alloy material.

5. The method according to claim 1, wherein the second component section is joined to the fusion area, which is coated with the adhesive layer and is part of the first component section, by welding or soldering.

6. The method according to claim 1, wherein prior to joining both the fusion area, which is coated with the adhesive layer and is part of the first component section, and a fusion area of the second component section are cleansed or cleaned.

7. The method according to claim 2, wherein prior to joining both the fusion area, which is coated with the adhesive layer and is part of the first component section, and a fusion area of the second component section are cleansed or cleaned.

8. The method according to claim 3, wherein the fusion area, which is coated with the adhesive layer and is part of the first component section, and the fusion area of the second component section are de-oxidized and degreased.

9. The method according to claim 1, wherein at least the fusion area of the first component section is coated with the adhesive layer in such a manner that a powdery nickel alloy material is applied on the fusion area of the first component section as the coating material for the adhesive layer, melted by means of laser powder build-up welding, and connected by metallurgical means to the first component section without any deep penetration melting of the material of the fusion area.

10. The method according to claim 2, wherein at least the fusion area of the first component section is coated with the adhesive layer in such a manner that a powdery nickel alloy material is applied on the fusion area of the first component section as the coating material for the adhesive layer, melted by means of laser powder build-up welding, and connected by metallurgical means to the first component section without any deep penetration melting of the material of the fusion area.

11. The method according to claim 3, wherein at least the fusion area of the first component section is coated with the adhesive layer in such a manner that a powdery nickel alloy material is applied on the fusion area of the first component section as the coating material for the adhesive layer, melted by means of laser powder build-up welding, and connected by metallurgical means to the first component section without any deep penetration melting of the material of the fusion area.

12. The method according to claim 4, wherein at least the fusion area of the first component section is coated with the adhesive layer in such a manner that a powdery nickel alloy material is applied on the fusion area of the first component section as the coating material for the adhesive layer, melted by means of laser powder build-up welding, and connected by metallurgical means to the first component section without any deep penetration melting of the material of the fusion area.

13. A method for producing a composite component, wherein the composite component comprises:
a first component section made of a magnesium-based material or an aluminum-based material; and
a second component section made of a high-strength material comprising an iron-based, nickel-based, titanium-based, or cobalt-based material,
the method comprising the following steps;
a) providing the first component section made of the magnesium-based material or the aluminum-based material;
b) coating the first component section made of the magnesium-based material or the aluminum-based material with an adhesive layer in at least one fusion area for the second component section, wherein a nickel-based material is used as the coating material for the adhesive layer; and
c) building up the second component section made of the high-strength material, which is coated with the adhesive layer and is part of the first component section made of the magnesium-based material or the aluminum-based material, by means of laser powder build-up welding.

14. The method according to claim 13, wherein the composite component is a composite gas turbine component.

15. The method according to claim 13, wherein the magnesium-based material or the aluminum-based material is a magnesium alloy material or an aluminum alloy material.

16. The method according to claim 13, wherein the nickel-based material, used as the coating material for the adhesive layer is a nickel alloy material.

17. The method according to claim 13, wherein the second component section made of the high-strength material is an iron-based, nickel-based, titanium-based, or cobalt-based material on the fusion area.

18. The method according to claim 13, wherein at least the fusion area of the first component section is coated with the adhesive layer in such a manner that a powdery nickel alloy material is applied on the fusion area of the first component section as the coating material for the adhesive layer, melted by means of laser powder build-up welding, and connected by metallurgical means to the first component section without any deep penetration melting of the material of the fusion area.

19. A product produced according to the method of claim 1.

20. A product produced according to the method of claim 13.
